(19) United States
(12) Patent Application Publication
(10) Pub. No.: US 2009/0291658 A1
(43) Pub. Date: Nov. 26, 2009

(54) Low Power Signal Processor

(76) Inventor: Michael Frank Castle, Calne (GB)

Correspondence Address: Michael Castle, Hazeland Farm, Bremhill, Calne, SN11 9JZ, omitted

(21) Appl. No.: 12/416,563

(22) Filed: Apr. 1, 2009

(30) Foreign Application Priority Data
Apr. 1, 2008 (GB) GB0805853.9

(51) Int. Cl. H04B 1/06

(52) U.S. Cl. 455/255

(57) ABSTRACT

There is disclosed a signal processor for reception of data over a radio link in which one or more signals are processed in separate channels each optimally adapted to the signal in the sub-band being processed. Such a signal processor uses less power and at lower cost than a conventional signal processor to yield the same performance. The signal processor uses a novel combination of both analog and digital signal processing.

### BACKGROUND

The present invention relates to a signal processor which searches and demodulates a signal with a low signal to noise ratio (SNR).

The invention can be applied to multicarrier and multimode radio receivers—a multicarrier radio has the ability to simultaneously operate on more than one frequency. The term ‘multicarrier’ also applies to a user terminal that is receiving multiple data streams on different radio frequency carriers.

### FIELD OF THE INVENTION

A multimode receiver can process several different kinds of signals using modulation schemes such as ASK (Amplitude Shift Keying), FSK (Frequency Shift Keying), or PSK (Phase Shift Keying). Such modulation schemes may employ two or more signal states, simultaneously transmitting more than 1 bit in each symbol; general multiple-state schemes are referred to generically as m-ary ASK, PSK. A Software Defined Radio (SDR) has the ability to be reprogrammed for different modulation schemes which different data rates. Embodiments of the present invention support existing standards as well as future standards, which require a multimode and multirate ability.

In a traditional radio the channel bandwidth is determined by using a fixed analog filter. In an SDR the channel bandwidth is determine using digital filters. Adaptive digital filters are used to discriminate against interfere in signals and to compensate for transmission path distortion. Such compensation, which improves the bit error ratio (BER) of the received signal, is impractical to implement with analog filters.

There are many applications for embodiments of this invention such as a two-way pager network to request emergency medical assistance or vehicle breakdown recovery. By way of example, a two-way pager with satellite location system such as GPS (Global Positioning System) enables lone workers, elderly/vulnerable people, children, animals or other objects to report their location. In addition, participants in outdoor activities such as skiing, biking and sailing are able to call for help and give their location.

Industrial applications include monitoring of remote sites, or building services such as vending machines, and plant equipment. The system can be used for one way or bidirectional (two-way) pagers. A two-way pager enables acknowledgements, machine-to-machine communications, and permits the extension to multi-hop and mesh networks. Other examples of two-way messaging are location-based services such as finding a friend, or directions to a parking place, restaurants or tourist attractions.

A mesh network covers a wide area by passing messages between nodes to reach the destination. A mesh network has low installation costs enabling emergency assistance service to be provided over a large area. A mesh network can route text messages in sparsely populated areas of the world, where it is uneconomic to install voice radio networks. Messages such as emergency requests reach their destination over multiple hops, with the message being repeated at each node, and passed to the next node in the chain.

### BACKGROUND OF THE INVENTION

The process of down-converting a radio frequency signal with a mixer to an Intermediate Frequency (IF) or to baseband is well known. When down-converting to baseband, it is necessary to mix the incoming radio frequency signal with a local oscillator signal with sine and cosine components (two components with a 90-degree mutual phase relationship) so the image band can be removed. The resulting baseband signal is a complex signal with real (in-phase I) component, and a quadrature (Q) component. After sampling both the I- and Q-components with Analog-to-Digital Converters (ADCs), digital signal processing is then performed on the baseband I&Q signals.

There are many well-known digital signal-processing methods. Software on a DSP (digital signal processor) or a FPGA (field programmable gate array) detects weak signals using digital filters, which require high speed and high resolution ADCs to accurately sample a channel (FIG. 4). In a receiver operating according to established techniques the ADC employed must have sufficient range to encompass the largest signal amplitude that is encountered, while having sufficiently small digitisation increments to accurately represent the smallest signals of interest. Either integer or floating-point computations are required to maintain high precision. Compared to analog signal processing, digital signal processing enables signals with lower SNR (signal to noise) ratio to be detected.

A practical radio channel in a real-world environment has a transmission characteristic which varies in amplitude and phase across the frequency span of the channel, a characteristic known as frequency-selective fading. The necessary process of adjusting the gain of the receiver over a frequency range, in order to equalize the power for all frequencies in the band occupied by the wanted signal is known as equalization. Equalization performed in the digital domain requires extensive computation that results in high power consumption compared to the present invention.

Many types of modulation are used for radio transmission of digital data. These include FSK (Frequency Shift Keying) in which signal elements are transmitted on two or more frequencies. PSK (Phase Shift Keying) in which the phase of the carrier wave is modulated in phase. In multi-carrier or OFDM (Orthogonal Frequency Division Multiplexing) transmission the input data stream is divided into multiple separate channels, each of which is used to transmit a portion of the input data at a low data rate (depending on the number of channels used), a process which, when combined with appropriate error coding is known to enhance reception performance in a mobile radio environment with multi-path reception and fading channels.

To digitize received signals having a wide bandwidth and high dynamic range signal requires a high resolution and high speed ADC. A high speed DSP is then required to process the resulting digital signals. The power consumed by the ADCs and signal processing electronics consumes a significant amount of supply current. The life of batteries for portable radio equipment is a known restriction. Embodiments of the present invention seek to provide a means of signal detection and demodulation, which uses less expensive semiconductor hardware and has a lower supply power requirement than conventional methods.

It is known, for example from US 2004/017847 (Motorola), to provide a radio communications device including a processor having a digital signal processor (DSP) coupled to a transceiver. The transceiver includes a digital-to-phase synthesizer having one or more independently variable frequency or phase signal outputs coupled to a transmitter and/or to a receiver. The variable frequency and phase outputs of the digital-to-phase synthesizer are mixed with corresponding received signals and are capable of frequency or phase modulating information signals for transmission. Amplitude modulated signals may be provided through polar modulation by combining synthesizer outputs at a summer. It is to be appreciated that this device is configured to perform mixing and other processing at radio frequencies, which are relatively high. Processing high frequency, for example RF, signals demands a lot of power in view of the high data rates.

### BRIEF SUMMARY OF THE DISCLOSURE

According to a first aspect, there is provided an apparatus for processing a signal in a radio receiver, comprising:
means for down-converting an incoming modulated Radio Frequency (RF) signal to a lower-frequency signal and outputting the down-converted signal to a plurality of analog mixers that split the down-converted signal into a plurality of channels;
at least one analog to digital converter;
each channel being individually provided with:
   a low pass analog filter;
   an automatic gain control; and
   a local oscillator;
wherein the signal in each channel is digitized and the channels are processed in parallel.

The automatic gain control for each channel may be operable to increase the resolution of the signal at the analog to digital converter so as to enable weak signals to be detected when there are strong signals in adjacent channels.

The apparatus may further comprise:
means for measuring a frequency of a predetermined signal within a channel; and
means for adjusting the local oscillator frequency so as to move the predetermined signal inside a narrow analog filter passband.

The apparatus may further comprise:
means to adjust the automatic gain control for the channel so as to increase the resolution of the remaining signals at the analog to digital converter.

In some embodiments each local oscillator is configured to perform a search across a segment of a band; and
each local oscillator is operable to search sequentially over a narrow bandwidth across its predefined segment;
so as to acquire a low signal-to-noise ratio signal through the use of parallel channels.

In some embodiments each local oscillator for each channel is configured to sweep across a segment of a band, a sweep rate determining the sensitivity to received signals; and
digital filtering means is provided to split each channel into additional sub-channels.

The apparatus may further comprise digital filtering and signal processing means to split each channel into sub-channels.

In some embodiments, each channel is individually provided with an analog to digital converter.

In other embodiments, at least one analog to digital converter is multiplexed across more than one channel.

In contrast to the device disclosed in US 2004/017847, the mixing and signal processing is done after the RF signal has been down-converted to baseband or an Intermediate Frequency (IF). The mixer array of present embodiments, which operates on signals that have already been down-converted, is to be contrasted to the prior art mixers, which operate on RF signals that have not yet been down-converted.

Generating frequencies in UHF or other RF bands in a mixer will use much more power (possibly 1000s of times more power) than processing relatively low frequency baseband or intermediate frequency signals in a mixer array. Accordingly, preferred embodiments of the present invention provide an apparatus with significantly lower power requirement than known prior art devices.

According to a second aspect, there is provided an apparatus for acquiring signals from a multi-hop or multicarrier radio receiver, using a plurality of receive antennas and receive chains, comprising:
means for down-converting an incoming modulated Radio Frequency (RF) signal to a lower-frequency signal and outputting the down-converted signal to a plurality of analog mixers that split the down-converted signal into a plurality of channels, each channel containing:
   an analog mixer;
   a low pass analog filter;
   an automatic gain control; and
   a local oscillator;
the apparatus further comprising at least one analogue to digital converter;
wherein a signal is acquired by assigning mixer channels to each signal path, in order to acquire signals in parallel, each of which are present at different power levels at each antenna input.

In other aspects, there is provided an apparatus for processing a signal in a radio receiver, comprising:
a plurality of analog mixers that split an incoming signal into channels;
a low pass analog filter for each channel;
an automatic gain control for each channel;
an analog to digital converter for each channel;
a local oscillator for each channel;
wherein the signal in each channel is digitized and the channels are processed in parallel.

The automatic gain control for each channel may be operable to increase the resolution of the signal at the analog to digital converter so as to enable weak signals to be detected when there are strong signals in adjacent channels.

There may be provided means for measuring a frequency of a predetermined signal within a channel, and means for adjusting the local oscillator frequency so as to move the predetermined signal outside the analog filter passband.

There may also be provided means to adjust the automatic gain control for the channel so as to increase the resolution of the remaining signals at the analog to digital converter.

Each local oscillator may be configured to perform a search across a segment of a band, and each local oscillator is operable to search sequentially over a narrow bandwidth across its predefined segment so as to acquire a low signal-to-noise ratio signal through the use of parallel channels.

Each local oscillator for each channel may be configured to sweep across a segment of a band, a sweep rate determining the sensitivity to received signals, and digital filtering means may be provided to split each channel into additional sub-channels.

Digital filtering and signal processing means may be provided to split each channel into sub-channels.

In other aspects, there is provided an apparatus for acquiring signals from a multi-hop or multicarrier radio receiver, using a plurality of receive antennas and receive chains, comprising:
a plurality of analog mixers that split the incoming receive paths into channels, each channel containing:
   an analog mixer;
   a low pass analog filter;
   an automatic gain control;
   an analogue to digital converter; and
   a local oscillator;
wherein a signal is acquired by assigning mixer channels to each signal path, in order to acquire signals in parallel, each of which are present at different power levels at each antenna input.

In other aspects, there is provided an apparatus to detect the audio tone frequencies from an audio channel such as a broadcast radio receiver comprising:
a plurality of analog mixers that each down-convert the audio input signal;
a low pass analog filter for each channel;
an automatic gain control for each channel;
an analog to digital converter for each channel; and
a local oscillator for each channel;
wherein low level audio signals are detected in parallel over a range of frequencies.

In other aspects, there is provided a method of acquiring and demodulating received signals over a wide dynamic range on parallel channels by way of the apparatus of the first aspect, wherein:
the automatic gain control for each channel is adjusted to improve the resolution of the signal at the analog to digital converter so as to enables weak signals to be detected when there are strong signals in adjacent channels.

In other aspects, there is provided a method to detect a weak signal, when a strong interfering signal is present within the same channel, by way of an apparatus of the first aspect, wherein:
the frequency of a strong signal within the channel is measured;
the local oscillator frequency is adjusted so that the strong signal frequency is moved outside the analog filter passband;
the channel automatic gain control is then adjusted to improve the resolution of the remaining signals at the analog to digital converter;
such that the weak signal is detectable, since the strong signal is no longer present within the channel.

In other aspects, there is provided a method to search for a signal of interest in parallel across a band by way of an apparatus as of the first aspect, wherein:
each local oscillator performs a search across a segment of the band;
each local oscillator is adjusted to search sequentially over a narrow bandwidth across its predefined segment;
a low signal to noise ratio signal is acquired using the search process, providing a fast acquisition time through the use of parallel channels.

In other aspects, there is provided a method to search for a signal of interest in parallel across a band by way of an apparatus of the first aspect, wherein:
each local oscillator for each channel sweeps across a segment of the band;
the sweep rate determines the sensitivity to received signals;
digital filtering is used to enhance sensitivity further, by splitting each channel into additional sub-channels.

In other aspects, there is provided a method of detecting received signals over a narrow bandwidth at high sensitivity by way of an apparatus of the first aspect, wherein:
each channel analog output is digitized with a high resolution analog to digital converter,
digital filtering and signal processing is performed to split each channel into sub-channels.

In other aspects, there is provided a method of operating a multi-hop wireless network receiver of the second aspect, wherein:
signals from each node are present over a wide dynamic range, since the range to each node varies;
each node transmits in a different channel;
the automatic gain control equalizes each channel gain,
the received signal from each node is demodulated simultaneously; and
signal processing is undertaken during short intervals to reduce power consumption.

In other aspects, there is provided a method of implementing diversity reception for a wireless sensor network with a low power consumption, by way of an apparatus of the first aspect, wherein:
there are a plurality of signal receive paths, with additional antennas or radio receivers;
the signals are combined from different antennas in order to improve the signal to noise ratio; and
signal processing is performed in both analog and digital domains so as to reduce power consumption.

In other aspects, there is provided a method of demodulating multi-carrier signals with low power consumption, by way of an apparatus of the second aspect, wherein:
each carrier is assigned to a unique channel within the mixer array;
each channel downconverts a different carrier frequency, and is sampled with a low resolution analog to digital converter; and
the digital operations are performed at low resolution, reducing overall power consumption.

In other aspects, there is provided a method of demodulating multi-carrier signals with diversity reception, by way of an apparatus of the second aspect, wherein:
each receive path and each carrier are assigned to separate channels on the mixer array;
each channel is sampled with a low-resolution analog to digital converter; and
the low-resolution signals from each receive path are added together, to enhance the signal to noise ratio.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made by way of example to the accompanying drawings, in which:

FIG. 1 shows an overview of the signal processing system;

FIG. 2 shows the filter frequency response of each channel (labelled Ch.1 to Ch.4);

FIG. 3 shows a parallel mixer array comprising of analog switches, followed by low pass filters, gain control, and ADC;

FIG. 4 shows the filter frequency response for reception of two different signals;

FIG. 5 shows a mixer to detect a signal as described in prior art; and

FIG. 6 shows the clock circuit to control the switch enable lines to the mixer array

### DETAILED DESCRIPTION

To achieve equalization and signal detection, embodiments of the present invention implement a low power signal processor combined with a parallel array of mixers and filters to detect weak signals within the analog baseband output of a radio receiver.

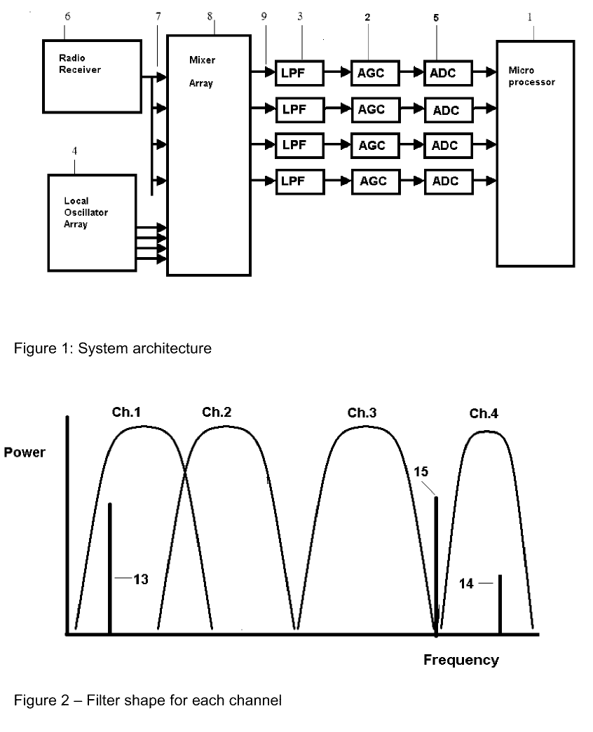

By reference to FIG. 1, the incoming modulated signal is down-converted to baseband in the radio receiver 6. The received baseband signal 7 is passed to a plurality of mixer channels that form a mixer array 8. Each channel consists of two analog mixers for I & Q channels respectively each followed by a low pass filter and AGC amplifier (Automatic Gain Control) amplifier. The outputs of the mixer array 9 are passed to an array of ADCs (Analog to Digital Converters) 3. Standard digital signal processing algorithms such as digital filtering are applied to each digital channel 1.

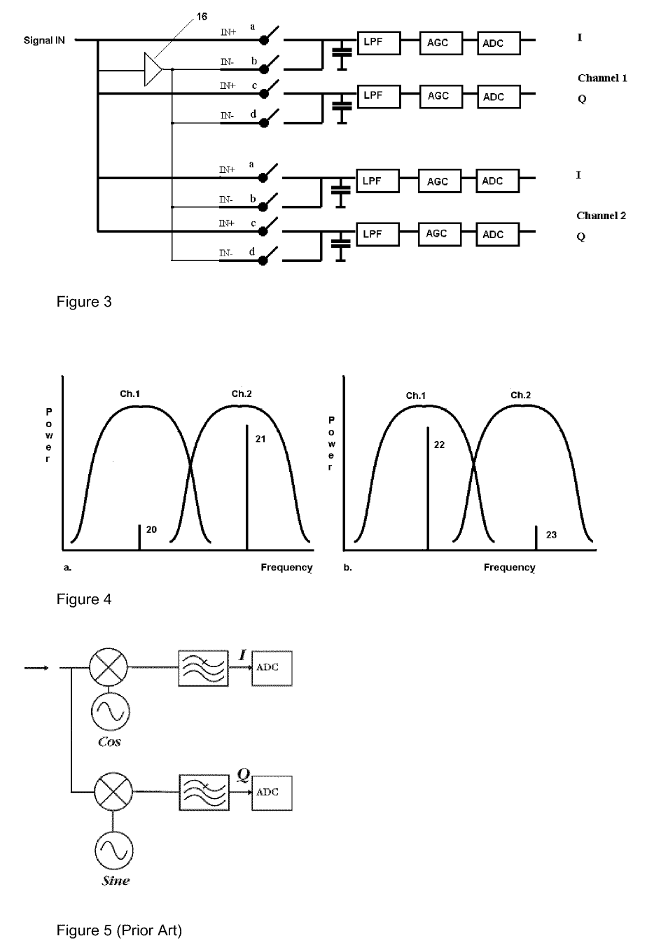

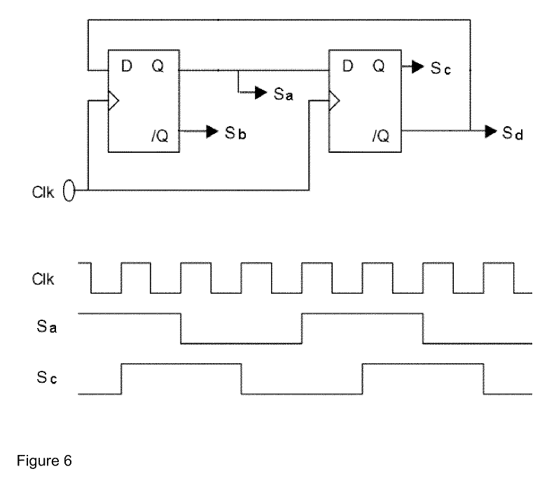

The local oscillator array consists of an array of programmable counters that generate digital square waves. FIG. 6 shows the clock from the local oscillator that opens and closes the switches to perform mixing of the input signal. The counter is programmed at a different local oscillator (LO) frequency for each channel. In FIG. 6, the clock from each programmable LO generates the correct square wave sequence to close and open the switches in the mixer array. The switch enable lines Sa, Sb, Sc, Sd in FIG. 6 operates the switch array shown in FIG. 3. The repetitive switching sequence is:

a: 1 1 0 0 1 1 0 0 . . .
b: 0 0 1 1 0 0 1 1 . . .
c: 0 1 1 0 0 1 1 0 . . .
d: 0 0 0 1 1 0 0 1 . . .

From the table, the analog switches are closed in the sequence a, c, b, d to perform the mixing.

By reference to FIG. 2, each channel in the mixer array is mixed with a local oscillator signal to create a baseband I and Q channel. The incoming analog signal input is inverted 16 and routed to the analog switches b and d. When switches a or c are closed, it has the effect of multiplying the input signal by +1, this is labelled as IN+. When switch b or d is closed, the input signal is multiplied by −1, this is labelled as IN−. In FIG. 3, the capacitor after the switches acts as an integrator or low pass filter.

The I channel is obtained by mixing the incoming signal with a local oscillator signal in the repetitive sequence 1, 0, −1, 0. The Q channel is created by mixing the incoming signal with a second local oscillator signal with a switching sequence in steps 0, 1, 0, −1. The mixing sequence has the effect of multiplying the incoming signal by sine and cosine waveforms. By reference to FIG. 2, each analog channel of the mixer array has four switches, which are closed in the sequence a, c, b, d. The I channel is created by multiplying the incoming signal in the sequence of +1, 0, −1, 0 on switches a (+1) and b (−1). The Q channel is created by multiplying in the sequence of 0, +1, 0, −1 on switches c (+1) and d (−1).

The incoming signal is mixed with a local oscillator to give I and Q baseband outputs for each channel. Only one of the switches a/b/c/d is closed at each interval, the switch closing interval being determined by the frequency of the local oscillator. The local oscillator (LO) array 4 provides output pulses with the correct timing and phase relationship between the four outputs to operate the analog switches in the mixer array, in order to down-convert a range of specific frequencies to baseband in the manner described above.

By way of example, with reference to FIG. 2, an input signal is split into 4 channels. The channel centre frequency can be changed, as well as each channel bandwidth. Channel 4 is shown with a narrow bandwidth compared to the other channels. Channel 3 is shown with a different spacing from Channels 1 and 2. In FIG. 2, signal 13 is detected in channel 1, while another signal 14 is detected in channel 4. In this example no signals are detected in channels 2 and 3.

An embodiment of this invention provides a method to search for a weak signal (at low SNR) within a band. The arrangement here disclosed allows the enhanced detection of weak signals in the presence of strong interfering signals on frequencies close-by. By way of example, FIG. 2 shows a signal 14 within channel 4, this signal does not appear within channels 1, 2 or 3.

A conventional system would require the ADC to have sufficient range to digitise the larger signal without distortion while at the same time having sufficient resolution to digitise the smaller wanted signal with high resolution to allow this signal to be demodulated without error in the later stages of the receiver. Embodiments of the present invention give the advantage that the weak signal 14 which would be otherwise masked by a strong signal 13, is present in a different channel. Embodiments of the present invention may also have the advantage that the digital filtering on each channel requires lower precision compared to a standard DSP architecture.

Another embodiment of this invention provides a method to detect a weak signal when a strong signal is nearby. Strong signals will block a weak signal when within the same channel. By way of example, in FIG. 2, a weak signal 14 is close to a strong signal 15. In order to detect the weak signal 14, the LO frequency is adjusted so the strong signal is outside the channel. The filter on channel 4 enables signal 14 to be detected, while rejecting signal 15.

In a practical radio system, the exact frequency of the transmitted signal is subject to some uncertainty because of component tolerances, thermal drift and Doppler shift. The exact tuned frequency of the receiver is subject to a similar uncertainty. In order to acquire a signal, the receiver must search over a sufficiently wide frequency range to allow for the maximum frequency uncertainty of both the receiver and the transmitter. To extend the search range over a wider range of frequencies the LO array 4 is re-programmed to generate outputs at other frequencies extending over the desired range, and the process of detecting a carrier is repeated for each LO frequency.

Increasing the number of channels in the mixer array enables signals to be detected over a larger frequency range. A large array of mixers enables the spectrum to be searched for signals simultaneously in different frequency sub-bands, but this increases the complexity of the solution. The use of small array of mixers requires that the spectrum be searched for signals sequentially in different frequency blocks, a process which results in a longer search time. The use of a small mixer array increases the overall power consumption since the entire radio receiver must be powered for a longer period while signals are being detected.

An embodiment employing an array of mixers enables a signal to be searched for concurrently in a number of separate sub-bands across a frequency range. The use of a parallel search provides increased sensitivity or reduced acquisition time compared to an analog receiver system that scans across the same bandwidth to acquire a signal. Each channel in the mixer array searches for a signal within a narrow bandwidth. The total noise power within the search bandwidth Pn is given by the standard formula Pn=kTB, in which k=Boltzmann's constant, T is the effective noise temperature and B is the bandwidth.

A narrow bandwidth is required to detect low SNR signals. A conventional single channel receiver has a long search time to acquire low SNR signals over a frequency range. Embodiments of the present invention search in parallel, which is much faster than a single channel search. The LO array is programmable to cover any frequency and the digital filter bandwidths are configurable to provide the optimal trade-off for a particular application in terms of the number of frequencies searched in parallel, the bandwidth of the individual search channels and the known characteristics of the radio signal. Compared to a conventional system that scans sequentially across a frequency search range, embodiments of the present invention acquire a signal much faster. In addition a parallel search as described can reduce overall power consumption for a power cycled system which searches periodically for signals of interest. A parallel search is completed faster and the system powered down compared to a single swept search.

Standard DSP systems require a high speed and high resolution ADC to accurately quantize signals in a bandwidth over wide dynamic range. Embodiments of the present invention have the advantage of using low resolution and low speed ADCs for each channel, at the same performance. The gain of the AGC amplifier is set such that the ADC always operates at its maximum resolution on the incoming waveform. It is not necessary to accurately quantize spikes on the incoming signal caused for example by impulse noise or interference; a limiter can be implemented to truncate spikes before the AGC amplifier, preventing them from reducing the gain and allowing the wanted signal to occupy the whole dynamic range of the ADC as it would have done in the absence of the spike.

By way of example, in FIG. 2, signal 14 has lower amplitude than signal 13, therefore the AGC gain is adjusted higher in channel 4 than channel 1. Embodiments of the present invention give the advantage that the weak signal 14 will be detected at similar resolution to the strong signal 13, due to the gain control for each channel. In embodiments of this invention, by virtue of the equalization in the analog domain, both signals would be quantized at similar resolutions.

In a standard DSP system, the gain is set according to the amplitude of the strongest signal 14, consequently signal 13 would be quantized with a lower resolution. In embodiments of the present invention, the equalization process in the signal amplitude domain enables lower resolution ADCs to be used compared to a standard DSP architecture. In addition, by performing equalization in the analog domain instead of equalization in the digital domain reduces the power consumed by the receiver compared to well-known DSP architectures.

The performance of a signal processor is determined by the speed of signal acquisition and the BER delivered for a signal with a given modulation format and signal-to-noise ratio. The power consumption is determined by the speed and resolution of the ADC, and the number and complexity of the necessary digital computations. Embodiments of the present invention use a lower resolution ADC than a standard DSP system, which in turn reduces the bit width (the number of bits concurrently processed) of the digital filters. In embodiments of the present invention, digital filtering is performed with fixed coefficients. Filtering using fixed coefficients can be implemented on a microprocessor without requiring a hardware multiplier.

Multi-carrier signals (such as OFDM or m-ary FSK) may be decoded using embodiments of the present invention by assigning a separate mixer channel to each carrier frequency or group of carrier frequencies. Multi-carrier signals are known to suffer from selective fading of some carriers due to multi-path reflections. Embodiments of the present invention enable multi-carrier signals to be decoded over a large dynamic range since each carrier (or group of carriers) has its own channel in the mixer array. The AGC level for a standard DSP system is set according to the mean signal power across the whole sampled bandwidth.

A standard DSP system decodes a multi-carrier signal by use of a Fast Fourier Transform (FFT). The digital signal processor implementation of an FFT requires high-speed multipliers with high precision. Embodiments of the present invention have the advantage of not performing an FFT, again reducing the power consumption of the receiver compared to a standard DSP system.

The received dynamic range of mesh networks is higher than a basestation network, since transmitters are both nearby and far away. The transmitter powers are adjusted in a basestation network such as GSM so the received signal strength is constant at the basestation receiver. To operate within a mesh network, a conventional DSP system requires use of a high resolution ADC due to the wide dynamic range of signals present. Embodiments of the present invention enable receiver operation without use of high resolution ADCs since equalization is performed in the analog domain.

A further embodiment enhances receiver sensitivity by increasing the resolution of the ADCs. Each ADC captures a narrow bandwidth compared to a standard signal processor which samples over a wider bandwidth. The advantage of embodiments of the present invention is that lower SNR signals can be detected in a narrower bandwidth compared to a standard signal processor.

The signal detection method in embodiments of the present invention enables messages to be received over a low bit rate narrow bandwidth radio link. Applications for narrow band radio receiver are remote reading of utility meters over radio, wireless sensor networks and other long-range data collection applications.

An embodiment of this invention provides for the reception of message data on an AM/FM broadcast radio. Such broadcast messages can be traffic information, weather reports, traffic congestion rerouting messages, parking space information, and emergency help requests. By way of example, DTMF (Dual Tone Multi frequency) or sub-sonic low frequency tones can be detected at the same time as a voice or music on a radio broadcast. The audio tones are inaudible due to their low level or being outside the human hearing frequency range and are used to operate display screens or other annunciators.

The signal detection method in embodiments of the present invention enables messages to be received over a narrow band radio link or over any type of voice or data channel. Message tones are detected using the tone detection scheme as described herein.

Embodiments of the present invention enable messages to be routed over a mesh radio network, to extend the coverage range. For example, users can send messages to each other, using other users to relay the messages. Data can be broadcast on AM/FM audio radio, and then be passed onto a multi-hop radio network. This would enable an emergency radio network to warn of approaching natural disasters such as earthquakes, or storms. The data can traverse between a radio link onto a voice channel on a radio or mobile phone.

Many radio signals suffer from selective fading due to multi-path propagation. To enhance the reception of radio signals in a fading environment it is a known practice to employ a diversity receiving system in which transmissions are received in two or more receiver channels designed to receive samples of the incoming signal having low cross-correlation. These signals are subsequently combined by known methods to provide an output signal having a higher reliability than could be obtained from any one single channel. Embodiments of the present invention provide diversity reception with additional antennas and radio receivers. Embodiments of the present invention perform a signal search for every input path, and the input path is chosen to give the highest SNR for each channel. Mesh networks experience more multi-path than networks with basestations, since the basestation has a more direct radio path to many users.

A further embodiment implements a mesh network receiver where the signals are sent from different transmitters simultaneously on different frequencies. Each channel in the mixer array demodulates signals over wide dynamic range due to the different ranges from each transmitter. In a mesh radio network in which nodes transmit simultaneously on different frequencies, each receiver requires a wide dynamic range, due to the differing ranges from each transmitter. In a mesh network, all receivers are power cycled and synchronized to maintain low power consumption. Each receiver is powered up at the same interval for a short period, and can receive several messages concurrently.

A multi-channel mesh network receiver enables a user to receive more than one signal simultaneously. Each signal is transmitted using a separate carrier frequency. Using the method here described, the AGC amplifier for each sub-band maintains the optimum dynamic range for each ADC, irrespective of differences in the received signal level in each individual channel. Reception of multiple signals enables a user to move from node to node, according to the signal strength. A user can receive messages on multiple channels simultaneously. A multi-channel transceiver enables messages to be sent over a mesh network. Messages such as emergency requests can reach their destination over multiple hops. Each node transmits on a different frequency, frequency reuse is achieved by using the minimum transmit power.

Embodiments of this invention provide signal processing to decode several transmissions simultaneously in a mesh network. This has an advantage over standard DSP systems due to the high dynamic range and lower power consumption.

In embodiments of the present invention, messages are received on multiple channels simultaneously. A multi-channel receiver enables messages to be received from different nodes simultaneously in a mesh network. Each node selects a transmit frequency so that it does not interfere with neighbouring node, frequency reuse is achieved by using the minimum transmit power. Standard mesh network receivers can only receive on a single channel, to receive messages from many nodes requires the receiver is powered up until all the messages are transmitted. Embodiments of the present invention have an advantage over standard mesh network receivers, because they can demodulate several transmissions simultaneously, so the receiver is powered for a short interval to reduce power consumption.

Diversity reception improves SNR especially within a mesh network. Embodiments of the present invention enable diversity reception along with multi-channel reception, which increases the range between nodes. By way of example, with reference to FIG. 4, two receive paths are shown, both are receiving the same signals but are at different signal strengths. In FIG. 4a, signal 20 is at low SNR, whereas signal 21 is a high SNR. In FIG. 4b, signal 22 is at high SNR, and signal 23 is at low SNR. The best overall SNR is obtained by choosing signal 21 on FIG. 4a and signal 22 on FIG. 4b.

From the foregoing, it will be seen that embodiments of this invention are well adapted to attain all the ends and objects hereinabove set forth together with other advantages which are obvious and which are inherent to the structure. It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

The prior art below describes other signal processing methods:

U.S. Pat. No. 6,230,000 Product detector and method therefor: This describes methods for downconverting a RF or IF signal to baseband. The patent provides enhanced RF mixer performance, with high dynamic range. It does not describe any signal processing method to search for and detect a weak signal. It does not describe an array of mixers at baseband or audio frequencies, or low power operation.

U.S. Pat. No. 6,493,338 Multichannel in-band signalling for data communications over digital wireless telecommunications networks: The patent describes a method to send and receive data over a voice channel of a mobile network. It does not describe how the received signal is detected, and no signal processing is required since the received signals have a high SNR. Also the power consumption of the receiver is not described.

U.S. Pat. No. 4,021,653 Digital programmable tone detector, (and U.S. Pat. No. 3,636,446): The patent describes a method to detect a tone over a narrow bandwidth, but it does not use an ADC, or any digital signal processing to detect low SNR signals.

U.S. Pat. No. 6,831,953 Method of, and a radio terminal for, detecting the presence of a 2-FSK signal: The patent describes a digital signal processing method for pagers. The downconverted signal is converted to digital, and no signal processing is performed in the analog domain.

U.S. Pat. No. 4,499,550 Walsh function mixer and tone detector: The patent shows how a sin and cosine mixer are used to detect a tone. It does describe the use of a parallel mixer array.

U.S. Pat. No. 4,258,423 Microprocessor controlled digital detector: The patent describes a method to search for a signal by varying the clock by a microprocessor. It does not describe using a parallel mixer array to speed up search time.

FR2902259 (WO2007/141311) System for Extraction and Analysis of significant radio electric signals: The application describes a method to split up the signal in the digital domain using polyphase filters. It does not describe power consumption, or the use of an analog mixer array.

US2007275679 Radio receiver for aviation communications and navigation: The application describes a method to receive on several different channels using several radio receivers. It does not describe power consumption, or the use of an analog mixer array

U.S. Pat. No. 7,187,237 Use of analog-valued floating-gate transistors for parallel and serial signal processing: The patent describes the use of transistors to perform gain adjustments. It does not describe the use of a low power mixer array.

JP2007027883 ASK Demodulator, Radio communication Device, and Reflected Wave Communication System: describes a ASK demodulator without use of an ADC. A mixer array is not used.

Prior art which describes other methods to detect radio signals:

U.S. Pat. No. 6,690,681 In-band signalling for data communications over digital wireless telecommunications network

U.S. Pat. No. 6,493,338 Multichannel in-band signalling for data communications over digital wireless telecommunications networks

U.S. Pat. No. 7,196,659 Combined global positioning system receiver and radio: describes a system for sending location information between devices using frequency modulated radio signal, which produces a wideband spectrum, with poor receive sensitivity. In contrast, this invention uses a signal processing method that detects narrow band signal at high sensitivity, and low power.

U.S. Pat. No. 7,142,900 Combined global positioning system receiver and radio: describes a system for sending location information using continuous tone coded squelch system (CTCSS) on a wideband FM family radio, and no signal processor description.

U.S. Pat. No. 6,011,510 GPS based search and rescue transceiver: radio transceiver uses phase modulation, and receiver does not have narrow bandwidth search or low power operation.

U.S. Pat. No. 5,334,974 Personal security system: does not describe low power operation of the receiver

U.S. Pat. No. 3,986,119 Emergency communication system: describes low power operation of the whole device but does not describe a signal processing method.

U.S. Pat. No. 4,593,273 Out-of-range personnel monitor and alarm: describes a radio-based system that sends an alarm when a person goes out of range.

U.S. Pat. No. 5,519,403 GPS communications multi-interface: describes an interface between GPS, radio and a status determiner.

U.S. Pat. No. 6,850,188 (Garmin) Combined GPS receiver and radio with enhanced display features: describes how distances are displayed

U.S. Pat. No. 5,847,679 GPS based search and rescue system: describes the use of an airborne relay station.

U.S. Pat. No. 4,644,351 Two way personal message system with extended coverage: describes messaging protocol.

### SUMMARY

Embodiments of the present invention seek to provide a signal detector scheme to receive messages over both an audio and radio channel. The signal processor preferably operates at low power to give long battery life.

### GLOSSARY

### ADC Analogue to Digital Converter

### AGC Automatic Gain Control

### DSP Digital Signal Processor

### FFT Fast Fourier Transform

### IF Intermediate Frequency

### FSK Frequency Shift Keying

LO Local Oscillator

1. An apparatus for processing a signal in a radio receiver, comprising:
means for down-converting an incoming modulated Radio Frequency (RF) signal to a lower-frequency signal and outputting the down-converted signal to a plurality of analog mixers that split the down-converted signal into a plurality of channels;
at least one analog to digital converter;
each channel being individually provided with:
a low pass analog filter;
an automatic gain control; and
a local oscillator;
wherein the signal in each channel is digitized and the channels are processed in parallel.

2. An apparatus as claimed in claim 1, wherein the automatic gain control for each channel is operable to increase the resolution of the signal at the analog to digital converter so as to enable weak signals to be detected when there are strong signals in adjacent channels.

3. An apparatus as claimed in claim 1, further comprising:
means for measuring a frequency of a predetermined signal within a channel; and
means for adjusting the local oscillator frequency so as to move the predetermined signal inside a narrow analog filter passband.

4. An apparatus as claimed in claim 3, further comprising:
means to adjust the automatic gain control for the channel so as to increase the resolution of the remaining signals at the analog to digital converter.

5. An apparatus as claimed in claim 1, wherein:
each local oscillator is configured to perform a search across a segment of a band; and
each local oscillator is operable to search sequentially over a narrow bandwidth across its predefined segment;
so as to acquire a low signal-to-noise ratio signal through the use of parallel channels.

6. An apparatus as claimed in claim 1, wherein:
each local oscillator for each channel is configured to sweep across a segment of a band, a sweep rate determining the sensitivity to received signals; and
digital filtering means is provided to split each channel into additional sub-channels.

7. An apparatus as claimed in claim 1, further comprising digital filtering and signal processing means to split each channel into sub-channels.

8. An apparatus as claimed in claim 1, wherein each channel is individually provided with an analog to digital converter.

9. An apparatus as claimed in claim 1, wherein at least one analog to digital converter is multiplexed across more than one channel.

10. An apparatus for acquiring signals from a multi-hop or multicarrier radio receiver, using a plurality of receive antennas and receive chains, comprising:
means for down-converting an incoming modulated Radio Frequency (RF) signal to a lower-frequency signal and outputting the down-converted signal to a plurality of analog mixers that split the down-converted signal into a plurality of channels, each channel containing:
an analog mixer;
a low pass analog filter;
an automatic gain control; and
a local oscillator;
the apparatus further comprising at least one analogue to digital converter;
wherein a signal is acquired by assigning mixer channels to each signal path, in order to acquire signals in parallel, each of which are present at different power levels at each antenna input.

11. A method of acquiring and demodulating received signals over a wide dynamic range on parallel channels by way of an apparatus as claimed in claim 1, wherein:
the automatic gain control for each channel is adjusted to improve the resolution of the signal at the analog to digital converter so as to enables weak signals to be detected when there are strong signals in adjacent channels.

12. A method to detect a weak signal, when a strong interfering signal is present within the same channel, by way of an apparatus as claimed in claim 1, wherein:
the frequency of a strong signal within the channel is measured;
the local oscillator frequency is adjusted so that the strong signal frequency is moved outside the analog filter passband;
the channel automatic gain control is then adjusted to improve the resolution of the remaining signals at the analog to digital converter;
such that the weak signal is detectable, since the strong signal is no longer present within the channel.

13. A method to search for a signal of interest in parallel across a band by way of an apparatus as claimed in claim 1, wherein:
each local oscillator performs a search across a segment of the band;
each local oscillator is adjusted to search sequentially over a narrow bandwidth across its predefined segment;
a low signal to noise ratio signal is acquired using the search process, providing a fast acquisition time through the use of parallel channels.

14. A method to search for a signal of interest in parallel across a band by way of an apparatus as claimed in claim 1, wherein:
each local oscillator for each channel sweeps across a segment of the band;
the sweep rate determines the sensitivity to received signals;
digital filtering is used to enhance sensitivity further, by splitting each channel into additional sub-channels.

15. A method of detecting received signals over a narrow bandwidth at high sensitivity by way of an apparatus as claimed in claim 1, wherein:
each channel analog output is digitized with a high resolution analog to digital converter,
digital filtering and signal processing is performed to split each channel into sub-channels.

16. A method of operating a multi-hop wireless network receiver according to claim 10, wherein:
signals from each node are present over a wide dynamic range, since the range to each node varies;
each node transmits in a different channel;
the automatic gain control equalizes each channel gain,
the received signal from each node is demodulated simultaneously; and
signal processing is undertaken during short intervals to reduce power consumption.

17. A method of implementing diversity reception for a wireless sensor network with a low power consumption, by way of an apparatus as claimed in claim 1, wherein:
the signals are combined from plurality of signal receive paths in order to improve the signal to noise ratio; and
signal processing is performed in both analog and digital domains so as to reduce power consumption.

18. A method of demodulating multi-carrier signals with low power consumption, by way of an apparatus as claimed in claim 10, wherein:
each carrier is assigned to a unique channel within the mixer array;
each channel downconverts a different carrier frequency, and is sampled with a low resolution analog to digital converter; and
the digital operations are performed at low resolution, reducing overall power consumption.

19. A method of demodulating multi-carrier signals with diversity reception, by way of an apparatus as claimed in claim 10, wherein:
each receive path and each carrier are assigned to separate channels on the mixer array;
each channel is sampled with a low-resolution analog to digital converter; and
the low-resolution signals from each receive path are added together, to enhance the signal to noise ratio.
